(19) United States
(12) Patent Application Publication
(10) Pub. No.: US 2022/0100566 A1
(43) Pub. Date: Mar. 31, 2022

(54) METRICS-BASED SCHEDULING FOR HARDWARE ACCELERATOR RESOURCES IN A SERVICE MESH ENVIRONMENT

(71) Applicant: Intel Corporation, Santa Clara, CA (US)

(72) Inventors: Mikko Ylinen, Lempaala (FI); Ismo Puustinen, Helsinki (FI)

(73) Assignee: Intel Corporation, Santa Clara, CA (US)

(21) Appl. No.: 17/547,961

(22) Filed: Dec. 10, 2021

(51) Int. Cl. G06F 9/50; G06F 21/60

(52) U.S. Cl. CPC G06F 9/505; G06F 9/5066; G06F 21/602; G06F 2221/2149; G06F 9/5038; G06F 2209/505; G06F 9/5083

(57) ABSTRACT

An apparatus to facilitate metrics-based scheduling for hardware accelerator resources in a service mesh environment is disclosed. The apparatus includes processors to collect metrics corresponding to communication links between microservices of a service managed by a service mesh; determine, based on analysis of the metrics, that a workload of the service can be accelerated by offload to a hardware accelerator device; generate a rebalancing request to cause the workload to be assigned to the hardware accelerator device for execution of the service; cause the workload to be annotated to indicate execution by the hardware accelerator device; and deploy, based on the annotation, the workload to the hardware accelerator device for execution in accordance with a restart policy corresponding to the service.

### FIELD

Embodiments relate generally to data processing and more particularly to metrics-based scheduling for hardware accelerator resources in a service mesh environment.

### BACKGROUND OF THE DESCRIPTION

Datacenters often leverage a microservice architecture to provide for network infrastructure services. A microservice architecture can arrange an application as a collection of loosely-coupled microservices. Microservices can refer to processes that communicate over a network to fulfill a goal using technology-agnostic protocols. In some cases, the microservices may be deployed using a container orchestration platform providing containerized workloads and/or services. The container orchestration platforms may utilize a service mesh to manage the high volume of network-based inter-process communication among the microservices. The service mesh is a dedicated software infrastructure layer for the microservices that includes elements to enable the communication among the microservices to be fast, reliable, and secure. The service mesh provides capabilities including service discovery, load balancing, encryption, observability, traceability, and authentication and authorization.

In a service mesh environment, a typical worker node in a compute cluster can handle hundreds of container workloads at the same time. These worker nodes may also have statically-attached specialized hardware accelerators optimized for compute intensive tasks. For instance, a class of hardware accelerators can be optimized to efficiently run cryptography and compression algorithms. However, the static hardware accelerator resources are typically not available for every workload running on a worker node due to the scarcity of the resources. In order to accelerate compute-heavy operations in a meaningful way, the hardware accelerator resources cannot be spread too thin to ensure quality of service (QoS).

Furthermore, in the service mesh environment, a container orchestration platform may be used to deploy the service(s) of the service mesh. A control plane scheduler of the container orchestration platform (managing the microservice architecture) can observe the hardware accelerator virtual functions (VFs) as “extended resources”. The number of available VFs on a given accelerator may be limited. For example, for a cryptographic accelerator card, there may be three physical accelerator engines which expose 16 VFs each, leading to 48 possible extended allocatable resources per node. The container applications of the microservice architecture may request one or more such accelerator resources, and after the accelerator resources of a node have run out, the control plane scheduler does not schedule workloads requesting such accelerator resources to the compute node (e.g., server CPU), even if the compute node has available compute resources. This may lead to underutilization of compute nodes.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate typical embodiments and are therefore not to be considered limiting of its scope. The figures are not to scale. In general, the same reference numbers are used throughout the drawing(s) and accompanying written description to refer to the same or like parts.

FIG. 1 illustrates a computing device employing an accelerator scheduler extender and restart policy controller for providing metrics-based scheduling for hardware accelerator resources in a service mesh environment, according to implementations of the disclosure.

FIG. 2 illustrates the scheduler extender of FIG. 1, according to one implementation of the disclosure.

FIG. 3 depicts a block diagram of a datacenter system implementing metrics-based scheduling for hardware accelerator resources in a service mesh environment, in accordance with implementations of the disclosure.

FIG. 4 is a flow diagram illustrating an embodiment of a method for metrics-based scheduling for hardware accelerator resources in a service mesh environment.

FIG. 5 is a flow diagram illustrating an embodiment of a method for metrics-based scheduling for hardware accelerator resources in a service mesh environment using a restart policy.

FIG. 6 is a schematic diagram of an illustrative electronic computing device to enable metrics-based scheduling for hardware accelerator resources in a service mesh environment, according to some embodiments.

### DETAILED DESCRIPTION

Implementations of the disclosure describe metrics-based scheduling for hardware accelerator resources in a service mesh environment. Cloud service providers (CSPs) are deploying solutions in datacenters where processing of a workload is distributed on various compute resources, such as central processing units (CPUs), graphics processing units (GPUs), and/or hardware accelerators (including, but not limited to, GPUs, field programmable gate arrays (FPGAs), application-specific integrated circuits (ASICs), cryptographic accelerators, compression accelerators, and so on). These compute resources are often running on the same platform and connected via physical communication links, such as peripheral component interconnect express (PCIe).

The datacenters used by CSPs to deploy a service mesh often leverage a microservice architecture to provide for network infrastructure services of the service mesh. A microservice architecture can arrange an application as a collection of loosely-coupled microservices. The microservices may be the processes that communicate over a network to fulfill a goal using technology-agnostic protocols. In some cases, the microservices can be deployed using a container orchestration platform providing containerized workloads and/or services. In some examples, the service may be a large service comprising hundreds of microservices working in conjunction with each other or may be a modest individual service. A workload may refer to a resource running on the cloud consuming resources, such as computing power. In some embodiments, an application, service, or microservice may be referred to as a workload, which denotes the workload can be moved around between different cloud platforms or from on-premises to the cloud or vice-versa without any dependencies or hassle.

The container orchestration platforms may utilize a service mesh to manage the high volume of network-based inter-process communication among the microservices. The service mesh is a dedicated software infrastructure layer for the microservices that includes elements to enable the communication among the microservices to be fast, reliable, and secure. The service mesh provides capabilities including service discovery, load balancing, encryption, observability, traceability, and authentication and authorization.

Hardware accelerators (also referred to herein as a hardware accelerator resources, hardware accelerator devices, accelerator resource, accelerator device, and/or extended resource) as discussed herein may refer to any of special-purpose central processing units (CPUs), graphics processing units (GPUs), general purpose GPUs (GPGPUs), field programmable gate arrays (FPGAs), application-specific integrated circuits (ASICs), inference accelerators, cryptographic accelerators, compression accelerators, other special-purpose hardware accelerators, and so on.

In some cases, the container, while being able to benefit from the use of an accelerator resource, may also be able to run without it with tradeoffs such as reduced performance and higher CPU utilization, or may not be sensitive to which accelerator resource it gets (e.g., FPGA vs. GPU vs. ASIC, etc.). These cases cannot be handled efficiently by conventional solutions. Moreover, if the static cluster completely runs out of accelerator resources for a certain type, new workloads remain in a pending state until resources become free again. This results in increased latency and reduced performance of the microservice architecture.

Conventional approaches for scheduling for hardware accelerator resources in a microservice architecture include the approach utilized by the control plane scheduler of a container orchestration platform, as follows. If a workload requests an extended resource, it is scheduled to a compute node that provides such a resource, and the available resource count on the node is decreased. The available resources on each node is static and this is reported to the control plane scheduler in the cluster during initialization. For example, a control plane scheduler of the container orchestration platform (managing the microservice architecture) can observe hardware accelerator virtual functions (VFs) as “extended resources”. The number of available VFs on a given accelerator may be limited. For example, for a cryptographic accelerator card, there may be three physical accelerator engines which expose 16 VFs each, leading to 48 possible extended allocatable resources per node. The container applications of the microservice architecture may request one or more such accelerator resources, and after the accelerator resources of a node have run out, the control plane scheduler does not schedule workloads requesting such accelerator resources to the compute node (e.g., server CPU), even if the compute node has available compute resources. This may lead to underutilization of compute nodes.

To overcome the limitation of workloads operating in a pending state, one conventional approach may provide an “infinite” number of virtual accelerator resources, and then have a subset of them contain actual accelerator hardware backend. However, the above conventional approach does not address the situation when the “actual” accelerator hardware backend resource(s) are fully utilized. If some of the granted resources are “empty” (i.e., do not contain a real hardware accelerator access), but are granted to enable scheduling of more than 48 applications, predictability is lost (e.g., no way to know if a service can fulfill the performance targets). In such a case, fully-optimized microservice graphs can observe bottlenecks in the flows, causing other hardware accelerator resources to be underutilized, because traffic volume is already cut at an earlier part of the microservice flow graph.

Furthermore, metrics-based scheduling in cloud orchestrators has not been used to grant hardware accelerator resources in conventional approaches. In one conventional approach, the Kubernetes project works on a workload “vertical autoscaler”. The vertical autoscaler monitors a workload's performance and dynamically adds more CPU time and/or memory for the workload if the workload's performance becomes degraded. However, this conventional approach focuses on increasing/decreasing native (e.g., CPU and memory) resources, and does not consider whether certain compute-intensive tasks could be offloaded (e.g., moved from one location to another location) to a dedicated hardware accelerator device and/or co-processor.

Other container orchestrator service mesh solutions work by having a sidecar proxy alongside every container application. If such a sidecar proxy uses the hardware accelerator for common tasks, such as transport layer security (TLS) handshake acceleration or HyperText Transport Protocol (HTTP) compression, the static limit of 48 resources (continuing the example discussed earlier), causes the application limit to be 48 pods containing the sidecar proxy along with the application container. Thus, this scheduling mechanism contributes directly to the problem of running out of resources, resulting in workloads that have to wait for accelerator resources to free up before they can be scheduled.

Implementations of the disclosure address the above-noted technical drawbacks by providing for metrics-based scheduling for hardware accelerator resources in a service mesh environment. In implementations herein, techniques are provided to utilize workload metrics (e.g., telemetry data) and hardware accelerator devices (e.g., special purposes CPUs, GPUs, GPGPUs, FPGAs, ASICs, inference accelerators, cryptographic accelerators, compression accelerators, other special-purpose hardware accelerators, etc.) to achieve scalable and dynamic compute resource allocation to workloads benefiting from acceleration in a compute cluster.

Implementations provide an accelerator scheduler extender that collects and analyzes metrics from the workloads. The metrics may refer to a unit of measurement that can be mapped to functions that could also be accelerated on a hardware accelerator device. For example, the metrics of number of TLS handshakes/second, or amount of data bytes compressed on CPU, can be mapped to a cryptographic or compressor (compression) accelerator. Using metrics-based hardware accelerator device scheduling, an optimized amount of hardware accelerator resources can be utilized by the compute cluster and allocated to those workloads utilizing them, while workloads not benefiting from hardware acceleration can be scheduled to run on CPU.

Implementations further provide for a restart policy controller that works in tandem with the accelerator scheduler extender to control how a service and/or the service's associated microservices are re-started in order to deploy a re-balanced workload to a scheduled hardware accelerator resource. A restart policy may be associated with the service and/or microservices, where the restart policy controls when and how often the service is stopped and re-started to enable the rebalancing of hardware accelerator resources for the service's workloads. As a result, a balanced approach to taking the service offline for restart is achieved.

Implementations of the discosure provide technical advantages over the conventional approaches discussed above. One technical advantage is that the hardware accelerator resources are better targeted as they are dynamically used to remove bottlenecks in the microservice flow graph and an optimized amount of hardware accelerators resources are implemented and utilized. Another technical advantage is that the hardware accelerator resources do not go to containers with so little usage that the resulting overhead would decrease application performance. A further technical advantage is that the nodes do not run underutilized as frequently (as the maximum number of containers running on the node is no longer determined by the available accelerator resources (e.g., in the service mesh use case)) and increases application density.

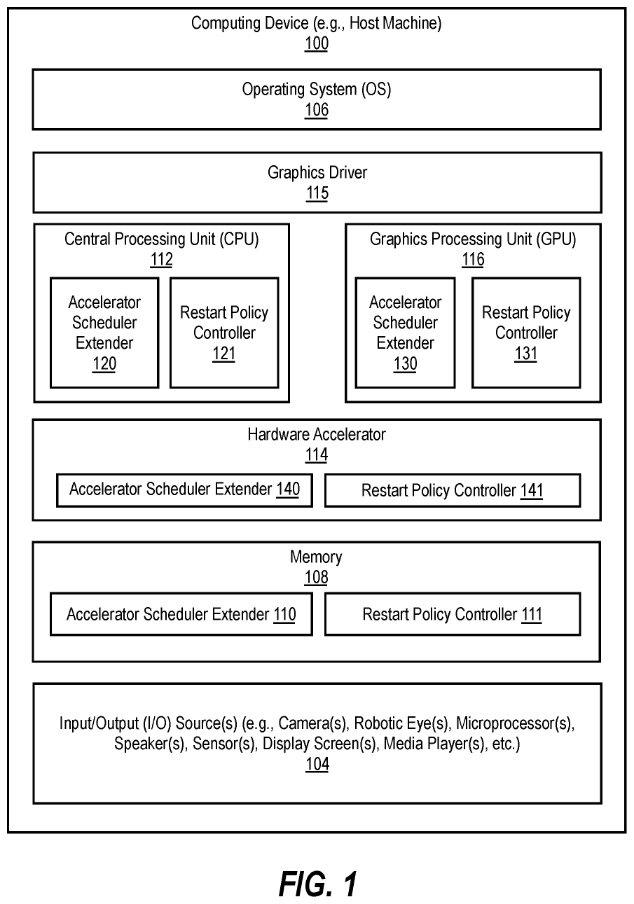

FIG. 1 illustrates a computing device 100 employing an accelerator scheduler extender and restart policy controller for providing metrics-based scheduling for hardware accelerator resources in a service mesh environment, according to implementations of the disclosure. Computing device 100 represents a communication and data processing device including or representing (without limitations) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs) , Internet of Things (IoT) devices, laptop computers, desktop computers, server computers, set-top boxes (e.g., Internet based cable television set-top boxes, etc.), global positioning system (GPS)-based devices, automotive infotainment devices, etc.

In some embodiments, computing device 100 includes or works with or is embedded in or facilitates any number and type of other smart devices, such as (without limitation) autonomous machines or artificially intelligent agents, such as a mechanical agents or machines, electronics agents or machines, virtual agents or machines, electromechanical agents or machines, etc. Examples of autonomous machines or artificially intelligent agents may include (without limitation) robots, autonomous vehicles (e.g., self-driving cars, self-flying planes, self-sailing boats, etc.), autonomous equipment, self-operating construction vehicles, self-operating medical equipment, etc.), and/or the like. Further, “autonomous vehicles” are not limed to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 100 may include a computer platform hosting an integrated circuit (“IC”), such as a system on a chip (“SOC” or “SoC”), integrating various hardware and/or software components of computing device 100 on a single chip.

As illustrated, in one embodiment, computing device 100 may include any number and type of hardware and/or software components, such as (without limitation) graphics processing unit (“GPU” or simply “graphics processor”) 114, graphics driver (also referred to as “GPU driver”, “graphics driver logic”, “driver logic”, user-mode driver (UMD), user-mode driver framework (UMDF), or simply “driver”) 115, central processing unit (“CPU” or simply “application processor”) 112, memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of the computing device 100 and a user.

It is to be appreciated that a lesser or more equipped system than the example described above may be utilized for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The terms “logic”, “module”, “component”, “engine”, “circuitry”, “element”, and “mechanism” may include, by way of example, software, hardware and/or a combination thereof, such as firmware.

In one embodiment, as illustrated, accelerator scheduler extender 110 and restart policy controller 111 may be hosted by memory 108 in communication with I/O source(s) 104, such as microphones, speakers, etc., of computing device 100. In another embodiment, accelerator scheduler extender 110 and restart policy controller 111 may be part of or hosted by operating system 106. In yet another embodiment, accelerator scheduler extender 110 and restart policy controller 111 may be hosted or facilitated by graphics driver 115. In yet another embodiment, accelerator scheduler extender 110 and restart policy controller 111 may be hosted by or part of a hardware accelerator 114; for example, accelerator scheduler extender 110 and restart policy controller 111 may be embedded in or implemented as part of the processing hardware of hardware accelerator 114, such as in the form of accelerator scheduler extender 140 and restart policy controller 141. In yet another embodiment, accelerator scheduler extender 110 and restart policy controller 111 may be hosted by or part of graphics processing unit (“GPU” or simply graphics processor“) 116 or firmware of graphics processor 116; for example, accelerator scheduler extender 110 and restart policy controller 111 may be embedded in or implemented as part of the processing hardware of graphics processor 116, such as in the form of accelerator scheduler extender 130 and restart policy controller 131. Similarly, in yet another embodiment, accelerator scheduler extender 110 and restart policy controller 111 may be hosted by or part of central processing unit (”CPU⇄ or simply “application processor”) 112; for example, accelerator scheduler extender 110 and restart policy controller 111 may be embedded in or implemented as part of the processing hardware of CPU 112, such as in the form of accelerator scheduler extender 120 and restart policy controller 121. In some embodiments, accelerator scheduler extender 110 and restart policy controller 111 may be provided by one or more processors including one or more of a graphics processor, an application processor, and another processor, wherein the one or more processors are co-located on a common semiconductor package.

It is contemplated that embodiments are not limited to certain implementation or hosting of accelerator scheduler extender 110 and restart policy controller 111 and that one or more portions or components of accelerator scheduler extender 110 and restart policy controller 111 may be employed or implemented as hardware, software, or any combination thereof, such as firmware. In one embodiment, for example, the accelerator scheduler extender 110 and restart policy controller 111 may be hosted by a machine learning processing unit which is different from the GPU 116. In another embodiment, the accelerator scheduler extender 110 and restart policy controller 111 may be distributed between a machine learning processing unit and a CPU 112. In another embodiment, the accelerator scheduler extender 110 and restart policy controller 111 may be distributed between a machine learning processing unit, a CPU 112 and a GPU 116. In another embodiment, the accelerator scheduler extender 110 and restart policy controller 111 may be distributed between a machine learning processing unit, a CPU 112, a GPU 116, and a hardware accelerator 114.

It is further contemplated that embodiments are not limited to certain implementation or hosting of accelerator scheduler extender 110 and restart policy controller 111 and that one or more portions or components of accelerator scheduler extender 110 and restart policy controller 111 may be employed or implemented in more than one computing device (e.g., host machine) 100 and is not solely limited to implementation in a single computing device 100.

Computing device 100 may host network interface device(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(s). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMS, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

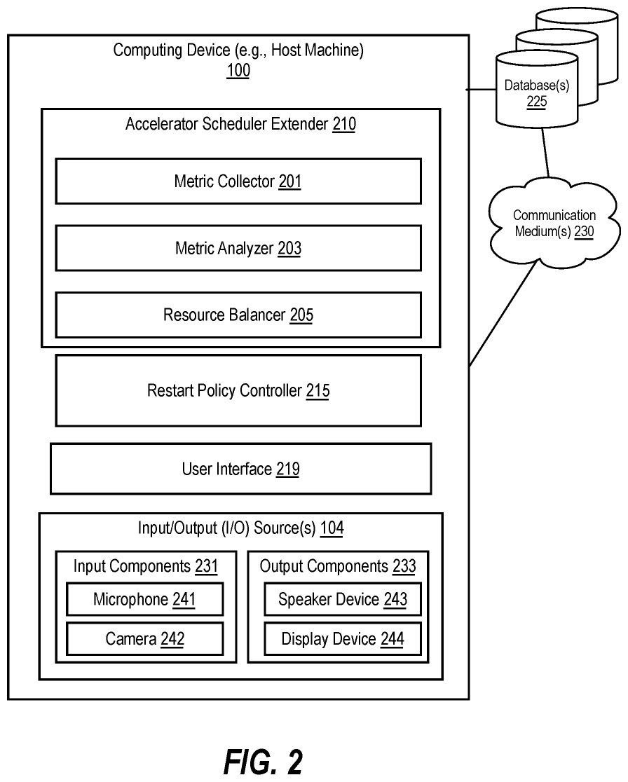

FIG. 2 illustrates accelerator scheduler extender and restart policy controller of FIG. 1, according to one implementation of the disclosure. For brevity, many of the details already discussed with reference to FIG. 1 are not repeated or discussed hereafter. In one embodiment, accelerator scheduler extender 210 may be the same as any of accelerator scheduler extenders 110, 120, 130, 140 described with respect to FIG. 1 and may include any number and type of components, such as (without limitations): metric collector 201; metric analyzer 203; and resource balancer 205. It is contemplated that embodiments are not limited to a certain implementation or hosting of metric collector 201, metric analyzer 203, and resource balancer 205, and that one or more portions or components of metric collector 201, metric analyzer 203, and resource balancer 205 may be employed or implemented in more than one computing device (e.g., host machine) 100 and they are not solely limited to implementation in a single computing device 100. For example, metric collector 201, metric analyzer 203, and/or resource balancer 205 may be hosted on multiple separate computing devices 100. In one embodiment, restart policy controller 215 may be the same as any of restart policy controllers 111, 121, 131, 141 described with respect to FIG. 1 and may include any number and type of components.

Computing device 100 is further shown to include user interface 219 (e.g., graphical user interface (GUI) based user interface, Web browser, cloud-based platform user interface, software application-based user interface, other user or application programming interfaces (APIs), etc.). Computing device 100 may further include I/O source(s) 104 having input component (s) 231, such as camera(s) 242 (e.g., Intel® RealSense™ camera), sensors, microphone(s) 241, etc., and output component(s) 233, such as display device(s) or simply display(s) 244 (e.g., integral displays, tensor displays, projection screens, display screens, etc.), speaker devices(s) or simply speaker(s), etc.

Computing device 100 is further illustrated as having access to and/or being in communication with one or more database(s) 225 and/or one or more of other computing devices over one or more communication medium(s) 230 (e.g., networks such as a proximity network, a cloud network, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or other details, and/or the like.

As aforementioned, computing device 100 may host I/O sources 104 including input component(s) 231 and output component(s) 233. In one embodiment, input component(s) 231 may include a sensor array including, but not limited to, microphone(s) 241 (e.g., ultrasound microphones), camera(s) 242 (e.g., two-dimensional (2D) cameras, three-dimensional (3D) cameras, infrared (IR) cameras, depth-sensing cameras, etc.), capacitors, radio components, radar components, scanners, and/or accelerometers, etc. Similarly, output component(s) 233 may include any number and type of display device(s) 244, projectors, light-emitting diodes (LEDs), speaker(s) 243, and/or vibration motors, etc.

As aforementioned, terms like “logic”, “module”, “component”, “engine”, “circuitry”, “element”, and “mechanism” may include, by way of example, software or hardware and/or a combination thereof, such as firmware. For example, logic may itself be or include or be associated with circuitry at one or more devices, such as accelerator scheduler extender 120, accelerator scheduler extender 130, and/or accelerator scheduler extender 140 hosted by CPU 112 (e.g., application processor), graphics processor 116, and/or hardware accelerator 114, respectively, of FIG. 1 having to facilitate or execute the corresponding logic to perform certain tasks.

For example, as illustrated, input component (s) 231 may include any number and type of microphone(s) 241, such as multiple microphones or a microphone array, such as ultrasound microphones, dynamic microphones, fiber optic microphones, laser microphones, etc. It is contemplated that one or more of microphone(s) 241 serve as one or more input devices for accepting or receiving audio inputs (such as human voice) into computing device 100 and converting this audio or sound into electrical signals. Similarly, it is contemplated that one or more of camera(s) 242 serve as one or more input devices for detecting and capturing of image and/or videos of scenes, objects, etc., and provide the captured data as video inputs into computing device 100.

As previously described, approaches for scheduling for extended resources in a microservice architecture have not been used to deploy hardware accelerator resources in a disaggregated environment in conventional approaches. The conventional approaches also have encountered latency and performance issues with over-utilized hardware resources. Embodiments provide for a novel technique for metrics-based scheduling for hardware accelerator resources in a service mesh environment. This novel technique is used to address the above-noted latency and/or performance issues in computing architectures seeking to implement rebalance workload deployment on hardware accelerator resources in a microservices architecture. Implementations of the disclosure utilize an accelerator scheduler extender 210 and restart policy controller 215 to provide the metrics-based scheduling for hardware accelerator resources in a service mesh environment.

With respect to FIG. 2, the accelerator scheduler extender 210 includes metric collector 201; metric analyzer 203; and resource balancer 205; to perform the metrics-based hardware accelerator service workload rebalancing of the accelerator scheduler extender 210. In implementations of the disclosure, the operations of components 201, 203, 205 of accelerator scheduler extender 210 utilize workload telemetry data and hardware accelerator devices (e.g., special purposes CPUs, GPUs, GPGPUs, FPGAs, ASICs, inference accelerators, cryptographic accelerators, compression accelerators, other special-purpose hardware accelerators, etc.) to achieve scalable and more dynamic compute resource allocation to workloads benefiting from acceleration in a compute cluster.

Implementations provide an accelerator scheduler extender 210, in communication with restart policy controller 215, that collects and analyses metrics from the workloads. The metrics are something that can be mapped to functions that could also be accelerated on a hardware accelerator device. For example, the number of TLS handshakes/second, or amount of data bytes compressed on CPU can be mapped to a cryptographic/compressor accelerator. Using metrics-based hardware accelerator device scheduling, an optimized amount of hardware accelerator resources can be made utilized by the cluster and allocated to those workloads utilizing them and workloads not benefiting from them can be scheduled to run on CPU.

In implementations herein, the metric collector 201 and metric analyzer 203 of accelerator scheduler extender 210 collects and analyze metrics from service workloads. The metrics may refer to telemetry data that can be mapped to functions that could be accelerated on a hardware accelerator resource. For example, the metrics of the number of TLS handshakes/second, or amount of data bytes compressed on CPU, can be mapped to a cryptographic/compressor accelerator by resource balancer 205. In one embodiment, the metrics can include telemetry data comprising at least one of a number of new TLS connections (e.g., per a determined time period), a number of transferred bytes per second, traffic patterns between the microservices, or utilization rate of hardware resources utilized by the microservices. Using metrics-based hardware accelerator scheduling, an optimized amount of hardware accelerator resources can be utilized and rebalanced (e.g., deployed or redeployed) to those workloads utilizing them and workloads not benefiting from them can be scheduled to run on CPU.

Implementations further provide for a restart policy controller 215 that works in tandem with the accelerator scheduler extender 210 to control how a service and/or the service's associated microservices are re-started in order to deploy a re-balanced workload to a scheduled hardware accelerator resource. A restart policy may be associated with the service and/or microservices, where the restart policy controls when and how often the service is stopped and re-started to enabled the rebalancing of hardware resources for the service's workloads. The restart policy controller 215 can access this restart policy (e.g., the restart policy is configured in the restart policy controller 215 or provided as an accessible file/location to the restart policy controller). As a result, a more balanced approach to taking the service offline for restart is achieved.

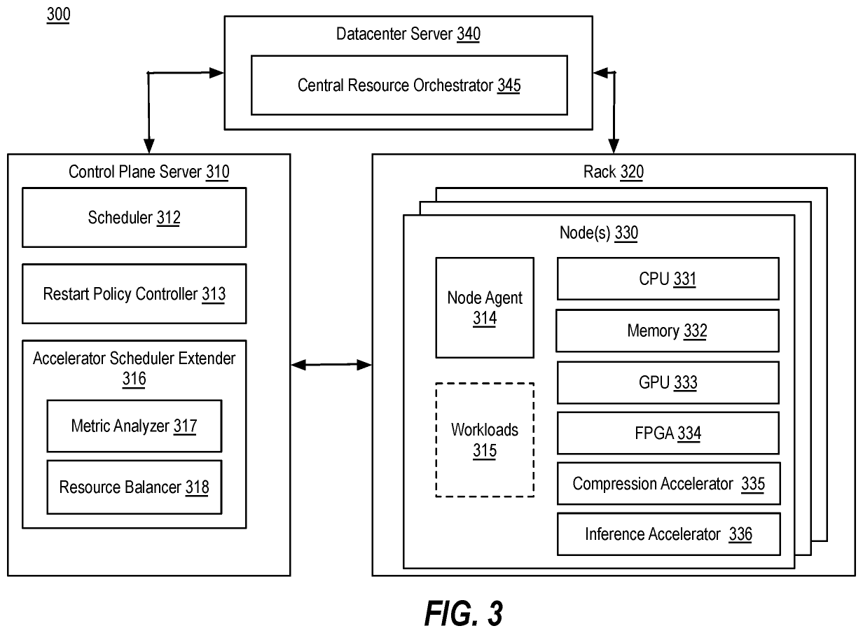

FIG. 3 depicts a block diagram of a datacenter system 300 (also referred to herein as datacenter 300) implementing metrics-based scheduling for hardware accelerator resources in a service mesh environment, in accordance with implementations of the disclosure. In one embodiment, datacenter system 300 includes a control plane server 310, a rack 320, and a datacenter server 340. In one implementation, control plane server 310 and rack 320 may be server computing devices operating to provide application server capabilities in the datacenter system 300. Datacenter server 340 may be a server computing device operating in datacenter system 300 to provide management and orchestration capabilities for the system 300.

In one embodiment, any of control plane server 310, rack 320, and/or datacenter server 340 may be a computing device comprising a set of hardware, software, firmware elements and/or any combination of hardware, software and/or firmware elements. In one example, control plane server 310, rack 320, and/or datacenter server 340 may include hardware circuitry, such as one or more of a CPU, a GPU, a hardware accelerator, and so on to execute one or more processes on control plane server 310, rack 320, and/or datacenter server 340, as described herein.

In some embodiments, control plane server 310 includes a scheduler 312, restart policy controller 313, and an accelerator scheduler extender 316. In one embodiment, scheduler 312, restart policy controller 313, and/or accelerator scheduler extender 316 can be implemented in separate computing devices and are communicably coupled via a network (not shown). Scheduler 312, restart policy controller 313, and/or accelerator scheduler extender 316 may be implemented using hardware circuitry, such as one or more of a CPU, a GPU, a hardware accelerator, and so on. In one embodiment, scheduler 312, restart policy controller 313, and/or accelerator scheduler extender 316 may be implemented using computing device 100 described with respect to FIG. 1. In one implementation, accelerator scheduler extender 316 is the same as accelerator scheduler extender 110 described with respect to FIG. 1 and/or accelerator scheduler extender 210 described with respect to FIG. 2. In one implementation, restart policy controller 313 is the same as restart policy controller 111 described with respect to FIG. 1 and/or restart policy controller 215 described with respect to FIG. 2.

More generally, the example scheduler 312, restart policy controller 313, and/or accelerator scheduler extender 316 of FIG. 3 may be implemented by hardware, software, firmware and/or any combination of hardware, software and/or firmware. Thus, for example, the example scheduler 312, restart policy controller 313, and/or accelerator scheduler extender 316 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

In some embodiments, rack 320 includes may include a node agent 314 and one or more resources organized into one or more nodes 330. The nodes 330 may include resources used to process tasks, such as tasks of a services of a service mesh of the datacenter 300. The resources of nodes 330 may include a CPU 331, memory 332, GPU 333, FPGA 334, compression accelerator 335, and/or inference accelerator 336. Other types of resources and/or more than one of each type of resources may be provisioned in a node 330 of the datacenter 300. In one embodiment, the node agent 314 may be implemented by hardware, software, firmware and/or any combination of hardware, software and/or firmware. Thus, for example, the example node agent 316 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

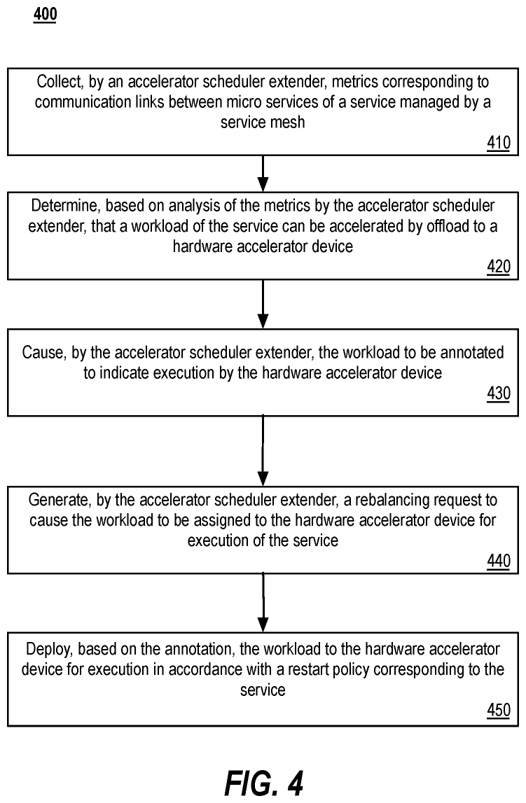

In one embodiment, datacenter server 340 includes a central resource orchestrator 345. Central resource orchestrator 345 may be implemented using hardware circuitry, such as one or more of a CPU, a GPU, a hardware accelerator, and so on. In one embodiment, central resource orchestrator 345 may be implemented using computing device 100 described with respect to FIG. 1. More generally, the example central resource orchestrator 345 of FIG. 4 may be implemented by hardware, software, firmware and/or any combination of hardware, software and/or firmware. Thus, for example, the central resource orchestrator 345 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). In one implementation, central resource orchestrator 345 operates to control orchestration of provisioning of resources for services of a service mesh hosted by datacenter 300.

Datacenter system 300 implements metrics-based scheduling for hardware accelerator resources in a service mesh environment, in accordance with implementations herein. As illustrated, the scheduler 312, restart policy controller 313, accelerator scheduler extender 316 run on the control plane server 310, which can be part of or separate from nodes 330 operating on rack 320. By bringing metrics-based knowledge about the applications resource usage and the enhanced accelerator resource aware scheduling capabilities provided by the accelerator scheduler extender 316, as described herein, an improved accelerator compute balance can be maintained in the datacenter system 300.

One example of embodiments herein includes a containerized web application that may be implemented in datacenter system 300. The web application is comprised of microservices, each of which is running in its own container using hardware resources of the datacenter system 300 (e.g., CPUs 331, GPUs 333, FPGAs 334, compression accelerator 335, inference accelerator 336 of rack 320) and talking to other microservices using protocols such as HyperText Transport Protocol (HTTP) or “g” Remote Procedure Call (gRPC). In one implementation, Transport Layer Security (TLS) may be utilized for the communication links between the services.

Several tools, such as service meshes, allow fine-grained gathering of statistics for any given communication link between microservices. For example, a service mesh might report the number of new TLS connections to a given service or the number of transferred bytes per second. In one example, the metrics may indicate that there is a lot of traffic from an inventory service to a storefront service, maybe as a result of repeating queries of inventory data (e.g., dynamic traffic patterns are typical with modern web applications).

Implementations herein periodically rebalance hardware accelerator resources (e.g., GPU 333, FPGA 334, compression accelerator 335, inference accelerator 336, and/or other types of provisioned hardware accelerator devices) based on collected metrics (e.g., telemetry data) and the known characteristics of the hardware accelerator devices available in the datacenter 300. Accelerator scheduler extender 316 may include a metric analyzer 317 to collect and analyze such metrics. The accelerator scheduler extender 316 includes a resource balancer 318 to cause workloads to be rebalanced to existing hardware accelerator resources (e.g., GPU 333, FPGA 334, compression accelerator 335, inference accelerator 336, and/or other types of provisioned hardware accelerator devices) in the datacenter 300, which may be located on another platform and connected via network, for purposes of processing a workload 315 of a service provided by control plane server 310.

In an example flow implemented by datacenter system 300, the metric analyzer 317 of the accelerator scheduler extender 316 collects metrics and analyzes relevant metrics associated with the service in order to identify opportunities to provide acceleration for the service. The metric analyzer 317 determines that the collected and analyzed metrics indicate that there is a potential to improving workload processing (e.g., query latency is improved if compression is accelerated), the resource balancer 318 of the accelerator scheduler extender 316 provides the microservice service with an annotation (or a revised annotation), indicating that the microservice is a candidate to be scheduled in an existing provisioned hardware accelerator (e.g., GPU 333, FPGA 334, compression accelerator 335, inference accelerator 336, and/or other types of provisioned hardware accelerator devices) of the datacenter 300. In one implementation, the annotation can refer to a comment, indication, or other documentation included with the code of the workload, microservice, and/or service.

The resource balancer 318 can create a rebalancing request to cause the workload to be deployed to the hardware accelerator resource (e.g., GPU 333, FPGA 334, compression accelerator 335, inference accelerator 336, and/or other types of provisioned hardware accelerator devices). In one implementation, the rebalancing request may be sent to the scheduler 312 to cause the workload 315 to be deployed (or redeployed) to the indicated hardware accelerator resource (e.g., GPU 333, FPGA 334, compression accelerator 335, inference accelerator 336, and/or other types of provisioned hardware accelerator devices). In one implementation, the accelerator scheduler extender 316 may communicate directly with scheduler 312 to cause workload to be deployed to the indicated hardware accelerator resource. If the hardware accelerator resource (e.g., GPU 333, FPGA 334, compression accelerator 335, inference accelerator 336, and/or other types of provisioned hardware accelerator devices) is remote to the control plane server 310, then the rebalancing request can be sent to the node agent 314 corresponding to the node 330 of the hardware accelerator resource (e.g., GPU 333, FPGA 334, compression accelerator 335, inference accelerator 336, and/or other types of provisioned hardware accelerator devices). The node agent 314 can cause the workload 315 to be allocated to the hardware accelerator resource at the node 330.

In one implementation, the restart policy controller 313 works in tandem with the accelerator scheduler extender 316 to control how a service and/or the service's associated microservices are re-started in order to deploy a re-balanced workload 315 to a scheduled hardware accelerator resource (e.g., GPU 333, FPGA 334, compression accelerator 335, inference accelerator 336, and/or other types of provisioned hardware accelerator devices). For example, a restart policy may be associated with the service and/or microservices, where the restart policy controls when and how often the service is stopped and re-started to enabled the rebalancing of hardware resources for the service's workloads. The restart policy controller 313 can access this restart policy (e.g., the restart policy is configured in the restart policy controller 313 or provided as an accessible file/location to the restart policy controller). In one implementation, the restart policy controller 313 provides a second annotation for the workload 315 indicating the particular restart policy that applies to the workload 315. In one implementation, the restart policy can include restarting automatically or waiting until a next scheduled restart (e.g., maintenance break). The scheduler 312 may utilize this second annotation as part of the deployment of the workload 315 to the indicated hardware accelerator resource.

Embodiments of the disclosure may not set any constraints to how a rebalancing/provisioning policy is created and/or implemented. For example, the rebalancing/provisioning policy can be based on a threshold value. In such an example, if traffic exceeds the pre-determined threshold amount or if there are over X amount of TLS handshakes per second, the service can be marked as a candidate for acceleration. However, the rebalancing/provisioning policy can also be complex and based on technologies such as neural networks, and the rebalancing/provisioning policy can be provided inputs as cluster-wide statistics. For example, informing the cluster utilization rate of hardware accelerator devices, expected future traffic patterns, and so on. The rebalancing/provisioning policies can be updated as more information about workload properties becomes available. A dynamic and adaptable policy for rebalancing and/or scheduling can be utilized herein for improved system resource utilization by implementations of the disclosure.

In one implementation, the accelerator scheduler extender 316, which collects and analyzes the metrics, can provide assurances that the metrics are not to be used for malicious intent, such as side channel attacks on the workload 315. This can be accomplished by executing the accelerator scheduler extender 316 inside a trusted execution environment (TEE), such as Intel® SGX™, AMD™ SEV™, or Trustzone™, for example. In one embodiment, executing the accelerator scheduler extender 316 inside a TEE can allow for protection of the metrics by gathering the metrics there in an encrypted format. In this example, the metrics are encrypted by the metrics gathering entity and are not decrypted outside of the enclave.

In some implementations, clusters may also be used to run regular batch jobs that can benefit from hardware accelerator (e.g., GPU 333, FPGA 334, compression accelerator 335, inference accelerator 336, and/or other types of provisioned hardware accelerator devices) acceleration. It may be that these batch jobs can be completed regardless of what type of hardware accelerator resource is used for acceleration (e.g., a compression batch job implemented using FPGA or a dedicated ASIC). In this case, the telemetry-based scheduling and/or rebalancing can be utilized to identify a hardware accelerator resource (e.g., GPU 333, FPGA 334, compression accelerator 335, inference accelerator 336, and/or other types of provisioned hardware accelerator devices) to schedule the service based on, for example, the past performance history, environmental conditions (e.g., cluster power budget), or other service level agreements (SLAs). Another feature of implementations herein may include support for removing hardware accelerator resources from processing workloads if another workload may benefit the particular hardware accelerator resource more (e.g., to make the web application more performant), while ensuring there is limited disruption to the application.

FIG. 4 is a flow diagram illustrating an embodiment of a method 400 for metrics-based scheduling for hardware accelerator resources in a service mesh environment. Method 400 may be performed by processing logic that may comprise hardware (e.g., circuitry, dedicated logic, programmable logic, etc.), software (such as instructions run on a processing device), or a combination thereof. More particularly, the method 400 may be implemented in one or more modules as a set of logic instructions stored in a machine- or computer-readable storage medium (also referred to herein as a non-transitory computer-readable storage medium) such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

The process of method 400 is illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3 may not be repeated or discussed hereafter. In one implementation, a datacenter system implementing an accelerator scheduler extender and/or a restart policy controller, such as accelerator scheduler extender 316 and/or restart policy controller 313 of datacenter system 300 of FIG. 3, may perform method 400.

The example process of method 400 of FIG. 4 begins at block 410 where a processing device executing an accelerator scheduler extender may collect metrics corresponding to communication links between microservices of a service managed by a service mesh. Then, at block 420, the processing device may determine, based on analysis of the metrics by the accelerator scheduler extender, that a workload of the service can be accelerated by offload to a hardware accelerator device.

Subsequently, at block 430, the processing device may cause, by the accelerator scheduler extender, the workload to be annotated to indicate execution by the hardware accelerator device. At block 440, the processing device may generate, by the accelerator scheduler extender, a rebalancing request to cause the workload to be assigned to the hardware accelerator device for execution of the service. Lastly, at block 450, the processing device may deploy, based on the annotation, the workload to the hardware accelerator device for execution in accordance with a restart policy corresponding to the service.

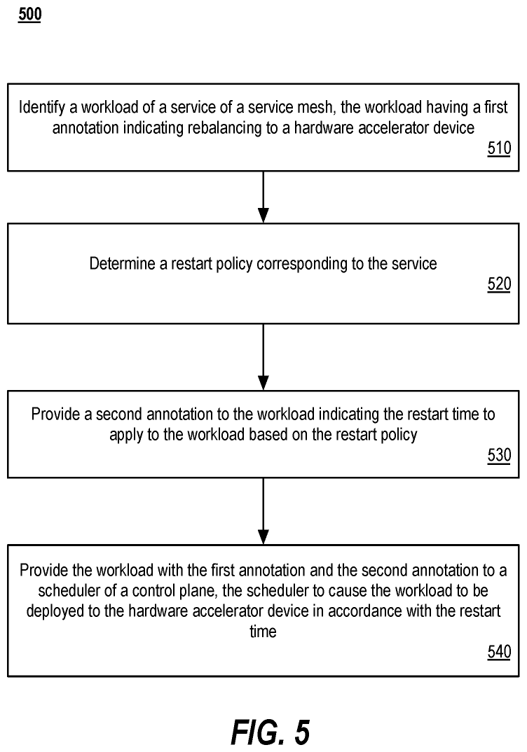

FIG. 5 is a flow diagram illustrating an embodiment of a method 500 for metrics-based scheduling for hardware accelerator resources in a service mesh environment using a restart policy. Method 500 may be performed by processing logic that may comprise hardware (e.g., circuitry, dedicated logic, programmable logic, etc.), software (such as instructions run on a processing device), or a combination thereof. More particularly, the method 500 may be implemented in one or more modules as a set of logic instructions stored in a machine- or computer-readable storage medium (also referred to herein as a non-transitory computer-readable storage medium) such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

The process of method 500 is illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-4 may not be repeated or discussed hereafter. In one implementation, a datacenter system implementing an accelerator scheduler extender and/or a restart policy controller, such as accelerator scheduler extender 316 and/or restart policy controller 313 of datacenter system 300 of FIG. 3, may perform method 500.

The example process of method 500 of FIG. 5 begins at block 510 where the processing device may identify a workload of a service of a service mesh. In one implementation, the workload can have a first annotation indicating rebalancing to a hardware accelerator device. Then, at block 520, the processing device may determine a restart policy corresponding to the service. In one implementation, the restart policy can include restarting automatically or waiting until a next scheduled restart (e.g., maintenance break).

Subsequently, at block 530, the processing device may provide a second annotation to the workload indicating the restart time to apply to the workload based on the restart policy. Lastly, at block 540, the processing device may provide the workload with the first annotation and the second annotation to a scheduler of a control plane. In one implementation, the scheduler can cause the workload to be deployed to the hardware accelerator device in accordance with the restart time.

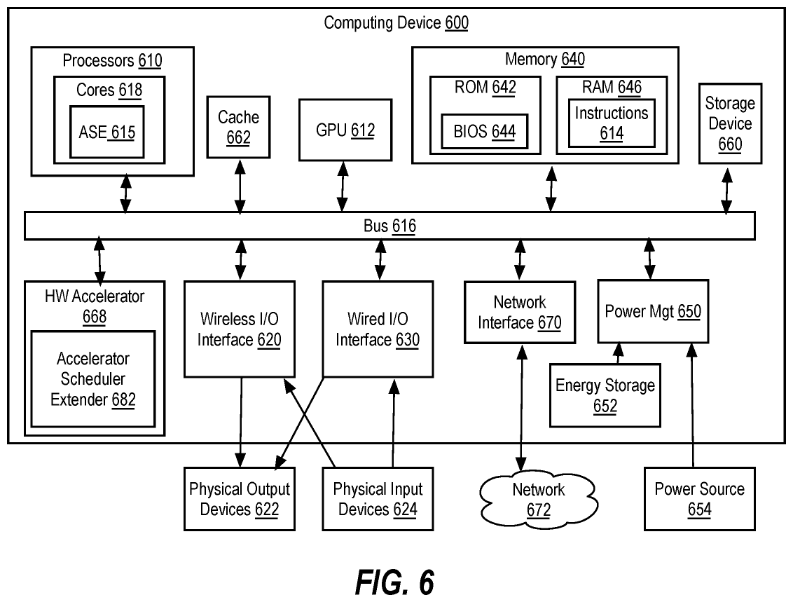

FIG. 6 is a schematic diagram of an illustrative electronic computing device 600 to enable metrics-based scheduling for hardware accelerator resources in a service mesh environment, according to some embodiments. In some embodiments, the computing device 600 includes one or more processors 610 including one or more processors cores 618 including an accelerator scheduler extender (ASE) 615, such as accelerator scheduler extender 110-140 described with respect to FIG. 1, accelerator scheduler extender 210 described with respect to FIG. 2, or accelerator scheduler extender 316 described with respect to FIG. 3. In some embodiments, the computing device 600 includes a hardware accelerator 668, the hardware accelerator including an accelerator scheduler extender 682, such as accelerator scheduler extender 110-140 described with respect to FIG. 1, accelerator scheduler extender 210 described with respect to FIG. 2, or accelerator scheduler extender 316 described with respect to FIG. 3. In some embodiments, the computing device is to provide metrics-based scheduling for hardware accelerator resources in a service mesh environment, as provided in FIGS. 1-5.

The computing device 600 may additionally include one or more of the following: cache 662, a graphical processing unit (GPU) 612 (which may be the hardware accelerator in some implementations), a wireless input/output (I/O) interface 620, a wired I/O interface 630, system memory 640 (e.g., memory circuitry), power management circuitry 650, non-transitory storage device 660, and a network interface 670 for connection to a network 672. The following discussion provides a brief, general description of the components forming the illustrative computing device 600. Example, non-limiting computing devices 600 may include a desktop computing device, blade server device, workstation, or similar device or system.

In embodiments, the processor cores 618 are capable of executing machine-readable instruction sets 614, reading data and/or instruction sets 614 from one or more storage devices 660 and writing data to the one or more storage devices 660. Those skilled in the relevant art can appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 618 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 600 includes a bus or similar communications link 616 that communicably couples and facilitates the exchange of information and/or data between various system components including the processor cores 618, the cache 662, the graphics processor circuitry 612, one or more wireless I/O interfaces 620, one or more wired I/O interfaces 630, one or more storage devices 660, and/or one or more network interfaces 670. The computing device 600 may be referred to in the singular herein, but this is not intended to limit the embodiments to a single computing device 600, since in certain embodiments, there may be more than one computing device 600 that incorporates, includes, or contains any number of communicably coupled, collocated, or remote networked circuits or devices.

The processor cores 618 may include any number, type, or combination of currently available or future developed devices capable of executing machine-readable instruction sets.

The processor cores 618 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 6 are of conventional design. Consequently, such blocks are not described in further detail herein, as they can be understood by those skilled in the relevant art. The bus 616 that interconnects at least some of the components of the computing device 600 may employ any currently available or future developed serial or parallel bus structures or architectures.

The system memory 640 may include read-only memory (“ROM”) 642 and random access memory (“RAM”) 646. A portion of the ROM 642 may be used to store or otherwise retain a basic input/output system (“BIOS”) 644. The BIOS 644 provides basic functionality to the computing device 600, for example by causing the processor cores 618 to load and/or execute one or more machine-readable instruction sets 614. In embodiments, at least some of the one or more machine-readable instruction sets 614 cause at least a portion of the processor cores 618 to provide, create, produce, transition, and/or function as a dedicated, specific, and particular machine, for example a word processing machine, a digital image acquisition machine, a media playing machine, a gaming system, a communications device, a smartphone, or similar.

The computing device 600 may include at least one wireless input/output (I/O) interface 620. The at least one wireless I/O interface 620 may be communicably coupled to one or more physical output devices 622 (tactile devices, video displays, audio output devices, hardcopy output devices, etc.). The at least one wireless I/O interface 620 may communicably couple to one or more physical input devices 624 (pointing devices, touchscreens, keyboards, tactile devices, etc.). The at least one wireless I/O interface 620 may include any currently available or future developed wireless I/O interface. Example wireless I/O interfaces include, but are not limited to: BLUETOOTH®, near field communication (NFC), and similar.

The computing device 600 may include one or more wired input/output (I/O) interfaces 630. The at least one wired I/O interface 630 may be communicably coupled to one or more physical output devices 622 (tactile devices, video displays, audio output devices, hardcopy output devices, etc.). The at least one wired I/O interface 630 may be communicably coupled to one or more physical input devices 624 (pointing devices, touchscreens, keyboards, tactile devices, etc.). The wired I/O interface 630 may include any currently available or future developed I/O interface. Example wired I/O interfaces include, but are not limited to: universal serial bus (USB), IEEE 1394 (“FireWire”), and similar.

The computing device 600 may include one or more communicably coupled, non-transitory, data storage devices 660. The data storage devices 660 may include one or more hard disk drives (HDDs) and/or one or more solid-state storage devices (SSDs). The one or more data storage devices 660 may include any current or future developed storage appliances, network storage devices, and/or systems. Non-limiting examples of such data storage devices 660 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 660 may include one or more removable storage devices, such as one or more flash drives, flash memories, flash storage units, or similar appliances or devices capable of communicable coupling to and decoupling from the computing device 600.

The one or more data storage devices 660 may include interfaces or controllers (not shown) communicatively coupling the respective storage device or system to the bus 616. The one or more data storage devices 660 may store, retain, or otherwise contain machine-readable instruction sets, data structures, program modules, data stores, databases, logical structures, and/or other data useful to the processor cores 618 and/or graphics processor circuitry 612 and/or one or more applications executed on or by the processor cores 618 and/or graphics processor circuitry 612. In some instances, one or more data storage devices 660 may be communicably coupled to the processor cores 618, for example via the bus 616 or via one or more wired communications interfaces 630 (e.g., Universal Serial Bus or USB); one or more wireless communications interfaces 620 (e.g., Bluetooth®, Near Field Communication or NFC); and/or one or more network interfaces 670 (IEEE 802.3 or Ethernet, IEEE 802.11, or Wi-Fi®, etc.).

Processor-readable instruction sets 614 and other programs, applications, logic sets, and/or modules may be stored in whole or in part in the system memory 640. Such instruction sets 614 may be transferred, in whole or in part, from the one or more data storage devices 660. The instruction sets 614 may be loaded, stored, or otherwise retained in system memory 640, in whole or in part, during execution by the processor cores 618 and/or graphics processor circuitry 612.

The computing device 600 may include power management circuitry 650 that controls one or more operational aspects of the energy storage device 652. In embodiments, the energy storage device 652 may include one or more primary (i.e., non-rechargeable) or secondary (i.e., rechargeable) batteries or similar energy storage devices. In embodiments, the energy storage device 652 may include one or more supercapacitors or ultracapacitors. In embodiments, the power management circuitry 650 may alter, adjust, or control the flow of energy from an external power source 654 to the energy storage device 652 and/or to the computing device 600. The power source 654 may include, but is not limited to, a solar power system, a commercial electric grid, a portable generator, an external energy storage device, or any combination thereof.

For convenience, the processor cores 618, the graphics processor circuitry 612, the wireless I/O interface 620, the wired I/O interface 630, the storage device 660, and the network interface 670 are illustrated as communicatively coupled to each other via the bus 616, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In another example, one or more of the above-described components may be integrated into the processor cores 618 and/or the graphics processor circuitry 612. In some embodiments, all or a portion of the bus 616 may be omitted and the components are coupled directly to each other using suitable wired or wireless connections.

The following examples pertain to further embodiments. Example 1 is an apparatus to facilitate metrics-based scheduling for hardware accelerator resources in a service mesh environment. The apparatus of Example 1 comprises one or more processors to: collect metrics corresponding to communication links between microservices of a service managed by a service mesh; determine, based on analysis of the metrics, that a workload of the service can be accelerated by offload to a hardware accelerator device; cause the workload to be annotated to indicate execution by the hardware accelerator device; generate a rebalancing request to cause the workload to be assigned to the hardware accelerator device for execution of the service; and deploy, based on the annotation, the workload to the hardware accelerator device for execution in accordance with a restart policy corresponding to the service.

In Example 2, the subject matter of Example 1 can optionally include wherein the metrics comprise telemetry data comprising at least one of a number of new transport layer security (TLS) connections, a number of transferred bytes per second, traffic patterns between the microservices, or utilization rate of hardware resources utilized by the microservices. In Example 3, the subject matter of any one of Examples 1-2 can optionally include wherein the annotation to cause a control plane scheduler of the service mesh to schedule the workload to the hardware accelerator device.

In Example 4, the subject matter of any one of Examples 1-3 can optionally include wherein the one or more processors to determine, based on the analysis of the metrics, that the workload can be accelerated by rebalancing to the hardware accelerator device of a determined type comprising at least one of a graphics processing unit (GPU), a field programmable gate array (FPGA), an application-specific integrated circuit (ASIC), a cryptographic accelerator device, an inference accelerator device, or a compression accelerator device.

In Example 5, the subject matter of any one of Examples 1-4 can optionally include wherein the rebalancing request is communicated to a central resource orchestrator of a datacenter hosting the one or more processors and the hardware accelerator device, the central resource orchestrator managing a set of hardware resources in a datacenter hosting at least the one or more processors and the hardware accelerator device. In Example 6, the subject matter of any one of Examples 1-5 can optionally include wherein the one or more processors comprise scheduler extender circuitry to expand operations of a control plane scheduler of the service mesh, and wherein the control plane scheduler to schedule workloads of the service on one or more available hardware resources in a datacenter, the one or more available hardware resources comprising at least the hardware accelerator device.

In Example 7, the subject matter of any one of Examples 1-6 can optionally include wherein the one or processors to execute a scheduler extender inside of a trusted execution environment (TEE) to isolate the scheduler extender, and wherein the scheduler extender to perform the collecting, the determining, the generating, and the causing. In Example 8, the subject matter of any one of Examples 1-7 can optionally include wherein the one or processors to identify the hardware accelerator based on past performance history of the hardware accelerator, environmental conditions of the hardware accelerator, or service level agreements (SLAs) corresponding to the service the hardware accelerator.

In Example 9, the subject matter of any one of Examples 1-8 can optionally include wherein the one or more processors further to communicate with a node agent executing on a node hosting the hardware accelerator device, the node agent to cause allocation of the workload to the hardware accelerator device at the node.

Example 10 is a non-transitory computer-readable storage medium for facilitating metrics-based scheduling for hardware accelerator resources in a service mesh environment. The non-transitory computer-readable storage medium of Example 10 having stored thereon executable computer program instructions that, when executed by one or more processors, cause the one or more processors to perform operations comprising: collecting, by the one or more processors, metrics corresponding to communication links between microservices of a service managed by a service mesh; determining, based on analysis of the metrics, that a workload of the service can be accelerated by offload to a hardware accelerator device; causing the workload to be annotated to indicate execution by the hardware accelerator device; generating a rebalancing request to cause the workload to be assigned to the hardware accelerator device for execution of the service; and deploying, based on the annotation, the workload to the hardware accelerator device for execution in accordance with a restart policy corresponding to the service.

In Example 11, the subject matter of Example 10 can optionally include wherein the metrics comprise telemetry data comprising at least one of a number of new transport layer security (TLS) connections, a number of transferred bytes per second, traffic patterns between the microservices, or utilization rate of hardware resources utilized by the microservices. In Example 12, the subject matter of Examples 10-11 can optionally include wherein the annotation to cause a control plane scheduler of the service mesh to schedule the workload to the hardware accelerator device.

In Example 13, the subject matter of Examples 10-12 can optionally include wherein the one or more processors to determine, based on the analysis of the metrics, that the workload can be accelerated by rebalancing to the hardware accelerator device of a determined type comprising at least one of a graphics processing unit (GPU), a field programmable gate array (FPGA), an application-specific integrated circuit (ASIC), a cryptographic accelerator device, an inference accelerator device, or a compression accelerator device.

In Example 14, the subject matter of Examples 10-13 can optionally include wherein the rebalancing request is communicated to a central resource orchestrator of a datacenter hosting the one or more processors and the hardware accelerator device, the central resource orchestrator managing a set of hardware resources in a datacenter hosting at least the one or more processors and the hardware accelerator device. In Example 15, the subject matter of Examples 10-14 can optionally include wherein the one or more processors comprise scheduler extender circuitry to expand operations of a control plane scheduler of the service mesh, and wherein the control plane scheduler to schedule workloads of the service on one or more available hardware resources in a datacenter, the one or more available hardware resources comprising at least the hardware accelerator device.

Example 16 is a method for facilitating metrics-based scheduling for hardware accelerator resources in a service mesh environment. The method of Example 16 can include collecting, by one or more processors, metrics corresponding to communication links between microservices of a service managed by a service mesh; determining, based on analysis of the metrics by the one or processors, that a workload of the service can be accelerated by offload to a hardware accelerator device; causing, by one or more processors, the workload to be annotated to indicate execution by the hardware accelerator device; generating, by one or more processors, a rebalancing request to cause the workload to be assigned to the hardware accelerator device for execution of the service; and deploying, by one or more processors based on the annotation, the workload to the hardware accelerator device for execution in accordance with a restart policy corresponding to the service.

In Example 17, the subject matter of Example 16 can optionally include wherein the metrics comprise telemetry data comprising at least one of a number of new transport layer security (TLS) connections, a number of transferred bytes per second, traffic patterns between the microservices, or utilization rate of hardware resources utilized by the microservices. In Example 18, the subject matter of Examples 16-17 can optionally include wherein the annotation to cause a control plane scheduler of the service mesh to schedule the workload to the hardware accelerator device.

In Example 19, the subject matter of Examples 16-18 can optionally include wherein the one or more processors to determine, based on the analysis of the metrics, that the workload can be accelerated by rebalancing to the hardware accelerator device of a determined type comprising at least one of a graphics processing unit (GPU), a field programmable gate array (FPGA), an application-specific integrated circuit (ASIC), a cryptographic accelerator device, an inference accelerator device, or a compression accelerator device. In Example 20, the subject matter of Examples 16-19 can optionally include wherein the rebalancing request is communicated to a central resource orchestrator of a datacenter hosting the one or more processors and the hardware accelerator device, the central resource orchestrator managing a set of hardware resources in a datacenter hosting at least the one or more processors and the hardware accelerator device.

Example 21 is a system for facilitating metrics-based scheduling for hardware accelerator resources in a service mesh environment. The system of Example 21 can optionally include a memory to store a block of data, and a processor communicably coupled to the memory to: collect metrics corresponding to communication links between microservices of a service managed by a service mesh; determine, based on analysis of the metrics, that a workload of the service can be accelerated by offload to a hardware accelerator device; cause the workload to be annotated to indicate execution by the hardware accelerator device; generate a rebalancing request to cause the workload to be assigned to the hardware accelerator device for execution of the service; and deploy, based on the annotation, the workload to the hardware accelerator device for execution in accordance with a restart policy corresponding to the service.

In Example 22, the subject matter of Example 21 can optionally include wherein the metrics comprise telemetry data comprising at least one of a number of new transport layer security (TLS) connections, a number of transferred bytes per second, traffic patterns between the microservices, or utilization rate of hardware resources utilized by the microservices. In Example 23, the subject matter of any one of Examples 21-22 can optionally include wherein the annotation to cause a control plane scheduler of the service mesh to schedule the workload to the hardware accelerator device.

In Example 24, the subject matter of any one of Examples 21-23 can optionally include wherein the one or more processors to determine, based on the analysis of the metrics, that the workload can be accelerated by rebalancing to the hardware accelerator device of a determined type comprising at least one of a graphics processing unit (GPU), a field programmable gate array (FPGA), an application-specific integrated circuit (ASIC), a cryptographic accelerator device, an inference accelerator device, or a compression accelerator device.

In Example 25, the subject matter of any one of Examples 21-24 can optionally include wherein the rebalancing request is communicated to a central resource orchestrator of a datacenter hosting the one or more processors and the hardware accelerator device, the central resource orchestrator managing a set of hardware resources in a datacenter hosting at least the one or more processors and the hardware accelerator device. In Example 26, the subject matter of any one of Examples 21-25 can optionally include wherein the one or more processors comprise scheduler extender circuitry to expand operations of a control plane scheduler of the service mesh, and wherein the control plane scheduler to schedule workloads of the service on one or more available hardware resources in a datacenter, the one or more available hardware resources comprising at least the hardware accelerator device.

In Example 27, the subject matter of any one of Examples 21-26 can optionally include wherein the one or processors to execute a scheduler extender inside of a trusted execution environment (TEE) to isolate the scheduler extender, and wherein the scheduler extender to perform the collecting, the determining, the generating, and the causing. In Example 28, the subject matter of any one of Examples 21-27 can optionally include wherein the one or processors to identify the hardware accelerator based on past performance history of the hardware accelerator, environmental conditions of the hardware accelerator, or service level agreements (SLAs) corresponding to the service the hardware accelerator.

In Example 29, the subject matter of any one of Examples 21-28 can optionally include wherein the one or more processors further to communicate with a node agent executing on a node hosting the hardware accelerator device, the node agent to cause allocation of the workload to the hardware accelerator device at the node.

Example 30 is an apparatus for facilitating metrics-based scheduling for hardware accelerator resources in a service mesh environment, comprising means for collecting metrics corresponding to communication links between microservices of a service managed by a service mesh; means for determining, based on analysis of the metrics, that a workload of the service can be accelerated by offload to a hardware accelerator device; means for causing the workload to be annotated to indicate execution by the hardware accelerator device; means for generating a rebalancing request to cause the workload to be assigned to the hardware accelerator device for execution of the service; and means for deploying, based on the annotation, the workload to the hardware accelerator device for execution in accordance with a restart policy corresponding to the service. In Example 31, the subject matter of Example 30 can optionally include the apparatus further configured to perform the method of any one of the Examples 17 to 20.

Example 32 is at least one machine readable medium comprising a plurality of instructions that in response to being executed on a computing device, cause the computing device to carry out a method according to any one of Examples 16-20. Example 33 is an apparatus for facilitating metrics-based scheduling for hardware accelerator resources in a service mesh environment, configured to perform the method of any one of Examples 16-20. Example 34 is an apparatus for facilitating metrics-based scheduling for hardware accelerator resources in a service mesh environment, comprising means for performing the method of any one of claims 16 to 20. Specifics in the Examples may be used anywhere in one or more embodiments.

The foregoing description and drawings are to be regarded in an illustrative rather than a restrictive sense. Persons skilled in the art can understand that various modifications and changes may be made to the embodiments described herein without departing from the broader spirit and scope of the features set forth in the appended claims.

What is claimed is:

1. An apparatus comprising:
one or more processors to:
collect metrics corresponding to communication links between microservices of a service managed by a service mesh;
determine, based on analysis of the metrics, that a workload of the service can be accelerated by offload to a hardware accelerator device;
cause the workload to be annotated to indicate execution by the hardware accelerator device;
generate a rebalancing request to cause the workload to be assigned to the hardware accelerator device for execution of the service; and
deploy, based on the annotation, the workload to the hardware accelerator device for execution in accordance with a restart policy corresponding to the service.

2. The apparatus of claim 1, wherein the metrics comprise telemetry data comprising at least one of a number of new transport layer security (TLS) connections, a number of transferred bytes per second, traffic patterns between the microservices, or utilization rate of hardware resources utilized by the microservices.

3. The apparatus of claim 1, wherein the annotation to cause a control plane scheduler of the service mesh to schedule the workload to the hardware accelerator device.

4. The apparatus of claim 1, wherein the one or more processors to determine, based on the analysis of the metrics, that the workload can be accelerated by rebalancing to the hardware accelerator device of a determined type comprising at least one of a graphics processing unit (GPU), a field programmable gate array (FPGA), an application-specific integrated circuit (ASIC), a cryptographic accelerator device, an inference accelerator device, or a compression accelerator device.

5. The apparatus of claim 1, wherein the rebalancing request is communicated to a central resource orchestrator of a datacenter hosting the one or more processors and the hardware accelerator device, the central resource orchestrator managing a set of hardware resources in a datacenter hosting at least the one or more processors and the hardware accelerator device.

6. The apparatus of claim 1, wherein the one or more processors comprise scheduler extender circuitry to expand operations of a control plane scheduler of the service mesh, and wherein the control plane scheduler to schedule workloads of the service on one or more available hardware resources in a datacenter, the one or more available hardware resources comprising at least the hardware accelerator device.

7. The apparatus of claim 1, wherein the one or processors to execute a scheduler extender inside of a trusted execution environment (TEE) to isolate the scheduler extender, and wherein the scheduler extender to perform the collecting, the determining, the generating, and the causing.

8. The apparatus of claim 1, wherein the one or processors to identify the hardware accelerator based on past performance history of the hardware accelerator, environmental conditions of the hardware accelerator, or service level agreements (SLAs) corresponding to the service the hardware accelerator.

9. The apparatus of claim 1, wherein the one or more processors further to communicate with a node agent executing on a node hosting the hardware accelerator device, the node agent to cause allocation of the workload to the hardware accelerator device at the node.

10. A non-transitory computer-readable storage medium having stored thereon executable computer program instructions that, when executed by one or more processors, cause the one or more processors to perform operations comprising:
collecting, by the one or more processors, metrics corresponding to communication links between microservices of a service managed by a service mesh;
determining, based on analysis of the metrics, that a workload of the service can be accelerated by offload to a hardware accelerator device;
causing the workload to be annotated to indicate execution by the hardware accelerator device;
generating a rebalancing request to cause the workload to be assigned to the hardware accelerator device for execution of the service; and
deploying, based on the annotation, the workload to the hardware accelerator device for execution in accordance with a restart policy corresponding to the service.

11. The non-transitory computer-readable storage medium of claim 10, wherein the metrics comprise telemetry data comprising at least one of a number of new transport layer security (TLS) connections, a number of transferred bytes per second, traffic patterns between the microservices, or utilization rate of hardware resources utilized by the microservices.

12. The non-transitory computer-readable storage medium of claim 10, wherein the annotation to cause a control plane scheduler of the service mesh to schedule the workload to the hardware accelerator device.

13. The non-transitory computer-readable storage medium of claim 10, wherein the one or more processors to determine, based on the analysis of the metrics, that the workload can be accelerated by rebalancing to the hardware accelerator device of a determined type comprising at least one of a graphics processing unit (GPU), a field programmable gate array (FPGA), an application-specific integrated circuit (ASIC), a cryptographic accelerator device, an inference accelerator device, or a compression accelerator device.

14. The non-transitory computer-readable storage medium of claim 10, wherein the rebalancing request is communicated to a central resource orchestrator of a datacenter hosting the one or more processors and the hardware accelerator device, the central resource orchestrator managing a set of hardware resources in a datacenter hosting at least the one or more processors and the hardware accelerator device.

15. The non-transitory computer-readable storage medium of claim 10, wherein the one or more processors comprise scheduler extender circuitry to expand operations of a control plane scheduler of the service mesh, and wherein the control plane scheduler to schedule workloads of the service on one or more available hardware resources in a datacenter, the one or more available hardware resources comprising at least the hardware accelerator device.

16. A method comprising:
collecting, by one or more processors, metrics corresponding to communication links between microservices of a service managed by a service mesh;
determining, based on analysis of the metrics by the one or processors, that a workload of the service can be accelerated by offload to a hardware accelerator device;
causing, by one or more processors, the workload to be annotated to indicate execution by the hardware accelerator device;
generating, by one or more processors, a rebalancing request to cause the workload to be assigned to the hardware accelerator device for execution of the service; and
deploying, by one or more processors based on the annotation, the workload to the hardware accelerator device for execution in accordance with a restart policy corresponding to the service.

17. The method of claim 16, wherein the metrics comprise telemetry data comprising at least one of a number of new transport layer security (TLS) connections, a number of transferred bytes per second, traffic patterns between the microservices, or utilization rate of hardware resources utilized by the microservices.

18. The method of claim 16, wherein the annotation to cause a control plane scheduler of the service mesh to schedule the workload to the hardware accelerator device.

19. The method of claim 16, wherein the one or more processors to determine, based on the analysis of the metrics, that the workload can be accelerated by rebalancing to the hardware accelerator device of a determined type comprising at least one of a graphics processing unit (GPU), a field programmable gate array (FPGA), an application-specific integrated circuit (ASIC), a cryptographic accelerator device, an inference accelerator device, or a compression accelerator device.

20. The method of claim 16, wherein the rebalancing request is communicated to a central resource orchestrator of a datacenter hosting the one or more processors and the hardware accelerator device, the central resource orchestrator managing a set of hardware resources in a datacenter hosting at least the one or more processors and the hardware accelerator device.
